(19) United States
(12) Patent Application Publication
(10) Pub. No.: US 2025/0317521 A1
(43) Pub. Date: Oct. 9, 2025

(54) IMAGE FORMING APPARATUS

(71) Applicant: Taito SUZUKI, Kanagawa (JP)

(72) Inventor: Taito SUZUKI, Kanagawa (JP)

(21) Appl. No.: 19/083,515

(22) Filed: Mar. 19, 2025

(30) Foreign Application Priority Data
Apr. 9, 2024 (JP) 2024-062820

(51) Int. Cl. H04N 1/00

(52) U.S. Cl. CPC H04N 1/00408; H04N 1/00896; H04N 2201/0094

(57) ABSTRACT

An image forming apparatus includes: a scanner to read an image on a document, the scanner including an operation unit including a panel; a plotter to print the image read by the scanner on a medium; a relay to relay the scanner and the plotter; a detector to detect a trigger generated by at least one of the scanner, the plotter, or the operation unit; and circuitry configured to control the scanner, the plotter, the relay, and the operation unit to: shift an operation state of at least one of multiple applications to operate the scanner, the plotter, the relay, and the operation unit to an energy-saving mode when the operation unit receives an instruction to shift the operation state to the energy-saving mode.

### CROSS-REFERENCE TO RELATED APPLICATION

This patent application is based on and claims priority pursuant to 35 U.S.C. §119(a) to Japanese Patent Application No. 2024-062820, filed on Apr. 9, 2024, in the Japan Patent Office, the entire disclosure of which is hereby incorporated by reference herein.

### BACKGROUND

### Technical Field

The present disclosure relates to an image forming apparatus.

### Related Art

In an image forming apparatus, there is a technique of determining a portion to be restored from an operation in energy saving on the basis of a trigger such as opening and closing of a cover, and a document and a printing paper set.

For example, there is a technique in which, even when a user instructs a shift to an energy-saving mode in a state where a read document is set on a document table to shift to the energy-saving mode, and then the user opens a cover of the document table in order to take out a left document, the energy-saving mode is continued, thereby reducing user's operation labor.

However, there is a disadvantage that the screen display and the system transition desired by the user are not performed at the restoration timing, and the convenience is poor.

### SUMMARY

The present disclosure described herein provides an image forming apparatus includes: a scanner to read an image on a document, the scanner including an operation unit including a panel; a plotter to print the image read by the scanner on a medium; a relay to relay the scanner and the plotter; a detector to detect a trigger generated by at least one of the scanner, the plotter, or the operation unit; and circuitry configured to control the scanner, the plotter, the relay, and the operation unit to: shift an operation state of at least one of multiple applications to operate the scanner, the plotter, the relay, and the operation unit to an energy-saving mode when the operation unit receives an instruction to shift the operation state to the energy-saving mode; receive, in advance from the operation unit, priority information to select one of: energy-saving priority to select the energy-saving mode over an activation mode; and activation priority to select the activation mode to activate the multiple applications over the energy-saving mode, from the operation unit; receive, in advance from the operation unit, screen setting information to set an operation screen displayed with priority on the panel among multiple operation screens; determine: an application to be restored from the energy-saving mode among the multiple applications; and an operation screen to be displayed on the panel at a time of restoration from the energy-saving mode among the multiple operation screens, based on the trigger detected by the detector, the priority information, and the screen setting information; display, on the panel, the operation screen at the time of restoration; and activate the application to be restored.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram describing a configuration example of an image forming apparatus;

FIG. 2 is a diagram illustrating a display example of a home screen displayed on a panel of an operation unit;

FIG. 3 is a diagram illustrating a display example when a copy application is selected;

FIG. 4 is a diagram illustrating an example of a screen for performing initial setting;

FIG. 5 is a flowchart describing a processing example from generation of a predetermined trigger to screen display;

FIG. 6 is a flowchart describing a processing example from detection of a trigger of scanner cover open and scanner document set to a restoration operation;

FIG. 7 is a flowchart describing a processing example from detection of a trigger of printer cover open and printing document set to a restoration operation;

FIG. 8 is a table illustrating a correspondence example between a trigger serving as a restoration factor and an application displayed on a panel at the time of energy-saving priority setting;

FIG. 9 is a table illustrating a correspondence example between a trigger serving as a restoration factor and system transition at the time of energy-saving priority setting;

FIG. 10 is a table illustrating a correspondence example between a trigger serving as a restoration factor and an application displayed on a panel at the time of activation priority and copy application priority setting;

FIG. 11 is a table illustrating a correspondence example between a trigger serving as a restoration factor and system transition at the time of activation priority and copy application priority setting;

FIG. 12 is a table illustrating a correspondence example between a trigger serving as a restoration factor and an application displayed on a panel at the time of activation priority and non-copy application priority setting;

FIG. 13 is a table illustrating a correspondence example between a trigger serving as a restoration factor and system transition at the time of activation priority and non-copy application priority setting;

FIG. 14 is a table illustrating a correspondence example with system transition when pressing of an operation panel is used as a trigger of a restoration factor; and

FIG. 15 is a block diagram describing an example of a hardware configuration of the image forming apparatus.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, the present embodiment will be described with reference to the accompanying drawings. In the drawings for describing the present embodiment, like elements or like components in function or shape are given like reference signs as far as distinguishable, and overlapping descriptions may be omitted.

The present embodiment improves usability of activation of each system and restoration from energy saving in an image forming apparatus including multiple systems. Hereinafter, “activation of each system and restoration from energy saving” is also appropriately referred to as “activation and energy saving restoration”.

The image forming apparatus includes a scanner control system, a plotter control system, and a relay system that relays each system, and the relay system performs interaction with an external device.

The scanner control system includes an operation unit in which a panel operated by a user is disposed.

The image forming apparatus determines an application to be activated (also referred to as “application to be restored”) based on a trigger at the time of activation and energy saving restoration, activates a system corresponding to the application to be activated, and switches the application to be displayed on the panel. Each of the above-described systems (scanner control system, plotter control system, and relay system) or the operation unit is activated by activating an application (also referred to as an “app”), for example, and can execute each processing.

When determining the application to be activated, the image forming apparatus determines the application to be activated using one of the energy-saving priority setting prioritizing the energy-saving mode and the activation priority setting prioritizing activation of the application selected by the user in advance, and switches the screen on which the application to be activated can be operated on the panel.

The image forming apparatus displays an operation screen (for example, a home screen and a screen of each application) on the panel of the operation unit in accordance with a trigger that causes activation and energy saving restoration. When an operation for using a specific application is performed, the image forming apparatus basically displays the application screen. The user selects whether to prioritize energy saving or activation, and displays an operation screen at the time of energy saving and restoration desired by the user on the basis of the selected priority.

Here, a transition example of the operation screen will be described. In the screen display of a comparative example, six steps are necessary as follows to start copying from the power-off state/energy-saving state (state in which the operation panel and each control system are in sleep to suppress power consumption).

(1) The user performs an operation of activation and energy saving restoration.

(2) The image forming apparatus transitions to a standby state (a state in which each application can operate).

(3) The image forming apparatus displays the HOME screen on the operation panel.

(4) The user selects a copy application from the HOME screen.

(5) The image forming apparatus displays a copy application screen on the operation panel.

(6) The user performs setting on the application screen and starts copying.

On the other hand, in the image forming apparatus, screen display can be performed in four steps as follows.

(1) The user performs an operation of activation and energy saving restoration.

(2) The image forming apparatus transitions to a standby state (a state in which each application can operate).

(3) The image forming apparatus displays a copy application screen on the operation panel. At this time, for example, the application screen to be displayed is switched by the initial setting in advance.

(4) The user performs setting on the application screen and starts copying.

In order to implement the above, the image forming apparatus adds a function of displaying a screen of which application with respect to what operation and setting when the user performs an operation of activation and energy saving restoration.

Details of the image forming apparatus will be described below.

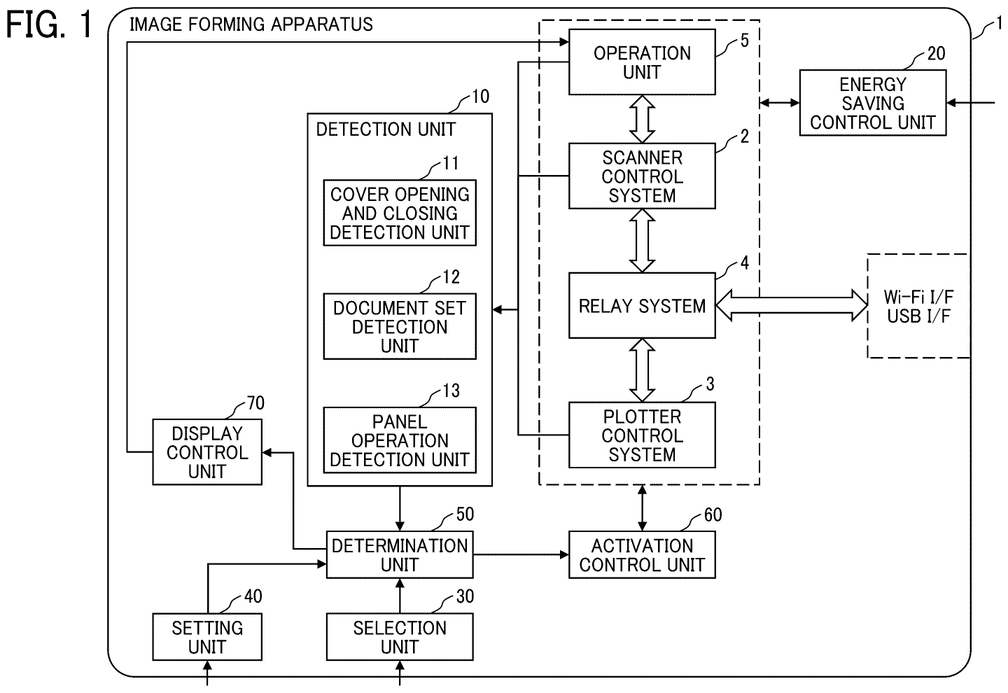

FIG. 1 is a diagram describing a configuration example of an image forming apparatus.

An image forming apparatus 1 includes a scanner control system 2 that controls a scanner, a plotter control system 3 that controls a plotter, and a relay system 4 that controls the scanner control system 2 and the plotter control system 3 and relays a request from an external device, and includes an operation unit 5 including a panel. The operation unit 5 is coupled to the scanner control system 2, and the panel is controlled by the scanner control system 2.

The scanner control system 2 and the relay system 4 are coupled via a scanner interface (SCN I/F).

The plotter control system 3 and the relay system 4 are coupled via a printer interface (PRN I/F).

The relay system 4 can be coupled to an external device such as an information processing terminal, a recording medium, or the like via an interface such as a universal serial bus (USB) interface (USB I/F) or a wireless fidelity (Wi-Fi) interface (Wi-Fi I/F). The relay system 4 may be referred to simply as “a relay”.

The image forming apparatus 1 includes a detection unit 10 (also referred to as “detector”), an energy saving control unit 20 (also referred to as “energy saving control device”), a selection unit 30 (also referred to as “selection device” and “priority selection device”), a setting unit 40 (also referred to as a “setting device” or a “screen setting device”), a determination unit 50 (also referred to as “determination device”), an activation control unit 60 (also referred to as “activation control device”), and a display control unit 70 (also referred to as “display control device”) as control devices for controlling switching between the normal mode and the energy-saving mode for each system and the operation unit 5, activating each system and the operation unit 5, and the like, which are surrounded by broken lines in FIG. 1. The normal mode is referred to also as “an activation mode”.

The functionality of the scanner control system 2, the plotter control system 3, the relay system 4, the energy saving control unit 20, the selection unit 30, the setting unit 40, the determination unit 50, the activation control unit 60, and the display control unit 70 may be implemented using circuitry or processing circuitry such as a central processing unit (CPU) 301 as illustrated in FIG. 15.

Here, the energy-saving mode is, for example, a state in which the image forming apparatus 1 is operated so as to reduce power consumption as compared with the normal mode.

The detection unit 10 detects a predetermined trigger generated by at least one of the scanner control system 2, the plotter control system 3, and the operation unit 5. The detection unit 10 notifies the determination unit 50 of the predetermined trigger as the detected detection result.

The predetermined trigger is favorably, for example, at least one of the following pieces of processing.
Opening and closing of the scanner cover included in the scanner control system 2, opening and closing of the printer cover included in the plotter control system 3, installation of a document in the scanner control system 2, installation of a recording medium such as printing paper in the plotter control system 3, and operation (panel touch, opening of the panel cover, or the like) on the panel included in the operation unit 5
Copy job execution, scanner job execution, and printer job execution

The copy job execution, the scanner job execution, or the printer job execution is favorably, for example, a state in which an operation of instructing execution of each job is started after opening and closing of the cover, installation of a document, paper, or the like, or a state in which an operation of executing each job excluding opening and closing of the cover, installation of a document, paper, or the like is started.

The detection unit 10 favorably includes, for example, a cover opening and closing detection unit 11, a document set detection unit 12, and a panel operation detection unit 13.

The cover opening and closing detection unit 11 detects opening and closing of the cover provided in the scanner control system 2 or the plotter control system 3.

In the scanner control system 2 or the plotter control system 3, the document set detection unit 12 detects that a document is set on a document set surface, or that printing paper is set at a printing paper set position (place).

The panel operation detection unit 13 detects panel operation of the operation unit 5.

When receiving an instruction to shift to the energy-saving mode, an energy saving control unit 20 shifts the operation state of at least one of multiple applications for implementing the system or the like from the normal mode to the energy-saving mode. The target for which the operation state is shifted is, for example, multiple applications for operating each system or each operation unit 5, and is, for example, an application for implementing the scanner control system 2, an application for implementing the plotter control system 3, an application for implementing the relay system 4, or an application for implementing the operation unit 5.

For example, the image forming apparatus 1 operates in one of the normal mode in which normal power is used and the energy-saving mode in which power consumption is reduced. Detailed description of the transition processing from the normal mode to the energy-saving mode is omitted here.

Whether the image forming apparatus 1 is operating in the normal mode or the energy-saving mode is favorably stored in, for example, a storage area that can be referred to by a control device or the like included in the image forming apparatus 1. As the referable storage area, for example, a system memory (MEM-P) 302 or a local memory (MEM-C) 306 in FIG. 15 described below may be used.

In the following description, the storage area that can be referred to by the control device or the like is a storage area that can be read or written by the control device or the like, and for example, the MEM-P 302, the MEM-C 306, a hard disk drive (HDD) 308, or the like in FIG. 15 to be described below, a removable memory that can be read or written via an interface with the outside, or the like may be used.

A selection unit 30 receives priority information in which one of energy-saving priority and activation priority is selected, and notifies the determination unit 50 of the priority information (outputs the priority information to the determination unit 50).

Here, the energy-saving priority is the energy-saving mode in which energy saving is prioritized, and the activation priority is an activation mode (normal mode) in which activation of an application is prioritized.

For example, the selection unit 30 displays a screen prompting the user to select the priority information on the panel of the operation unit 5, and receives the priority information selected by the user.

A setting unit 40 receives screen setting information for setting an operation screen to be preferentially displayed among multiple operation screens, and notifies the determination unit 50 of the screen setting information (outputs the screen setting information to the determination unit 50).

The operation screen is a HOME screen or a screen of an application to be activated. The screen of the application to be activated may be, for example, a screen on which an operation (start, stop, restart, end, or the like) related to the application to be activated is performed, and may be a screen on which an option to be used when the application is used can be set. The image forming apparatus 1 includes, for example, a screen of a copy application, a screen of a scanner application, a screen of a printer application, and a home screen as the multiple operation screens.

For example, the setting unit 40 displays a screen prompting the user to set the screen setting information on the panel of the operation unit 5, and receives the screen setting information set by the user.

The determination unit 50 determines an application to be restored from the energy-saving mode among the multiple applications and an operation screen to be displayed at the time of restoration on the panel among the multiple operation screens on the basis of a predetermined trigger detected by the detection unit 10, the priority information the notification of which has been given in advance from the selection unit 30, and the screen setting information the notification of which has been given in advance from the setting unit 40.

The determination unit 50 receives a detected trigger as a detection result when the detection unit 10 detects execution of a predetermined trigger.

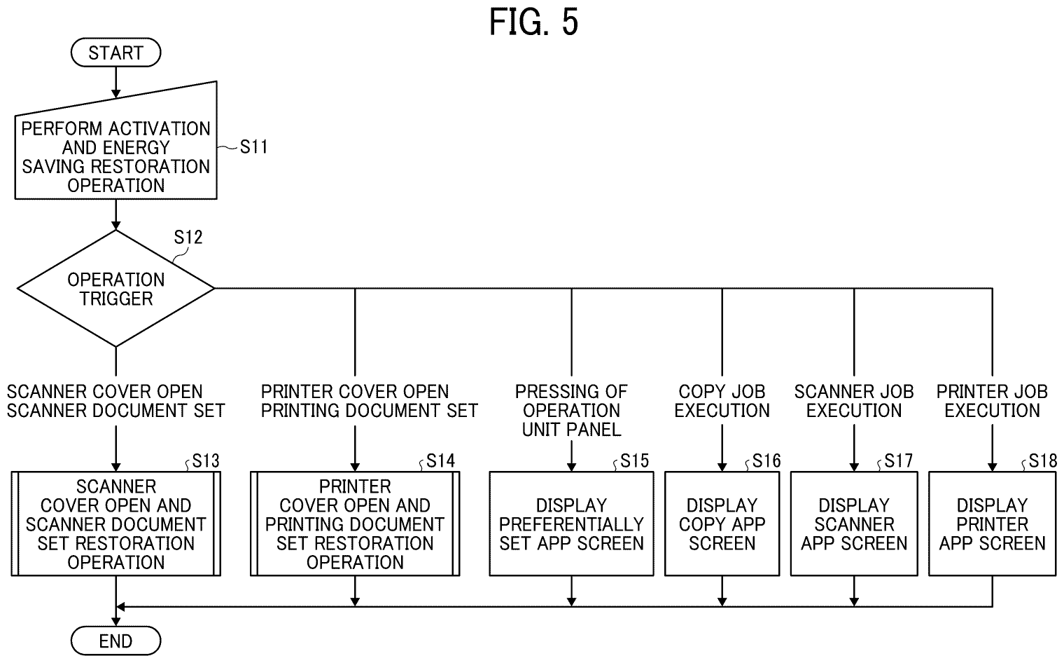

The operation of the determination unit 50 will be described below with reference to FIGS. 5 to 14.

An activation control unit 60 controls activation of an application to be restored from the energy-saving mode to the normal mode on the basis of the determination of the determination unit 50.

For example, the activation control unit 60 is notified of one or more applications to be restored from the determination unit 50, and controls activation of the applications at the timing when the notification is received.

For example, when the image forming apparatus 1 is operating in the energy-saving mode, the activation control unit 60 performs restoration from the energy-saving mode and shifts the mode to the normal mode, and when the image forming apparatus 1 is operating in the normal mode, the activation control unit 60 performs control not to perform restoration from the energy-saving mode.

A display control unit 70 displays the operation screen at the time of restoration on the panel of the operation unit 5 on the basis of the determination of the determination unit 50.

For example, the display control unit 70 is notified of the operation screen at the time of restoration from the determination unit 50, and displays the operation screen on the panel at the timing when the notification is received.

Here, an operation screen (user interface) displayed on the panel by the display control unit 70 will be described.

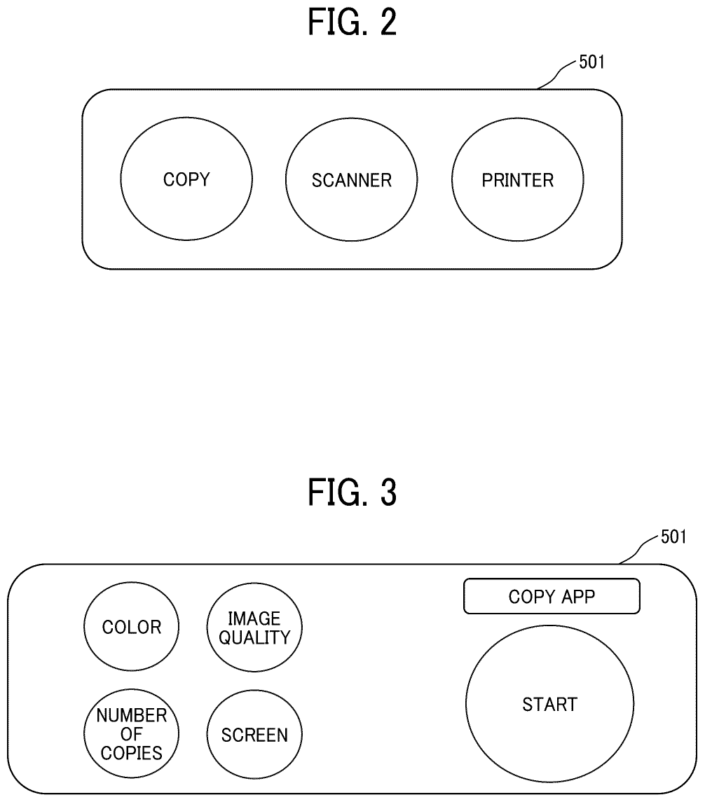

FIG. 2 is a diagram illustrating an example of a home screen displayed on a panel of an operation unit. FIG. 3 is a diagram illustrating a display example when a copy application is selected.

The home screen (HOME screen) is a screen for displaying an application list. FIG. 2 illustrates an example in which three applications: copy, scanner, and printer are displayed on a panel 501. When any application is selected on the panel 501, the screen shifts to a related screen of each application. As an example, FIG. 3 illustrates a display example when a copy application is selected. The operation screen in FIG. 3 is also a screen displayed when the display control unit 70 is notified of the screen of the copy application as the operation screen at the time of restoration from the determination unit 50.

After setting “color”, “number of copies”, and the like on the screen of the copy application, the user can start copying by pressing a “start” button.

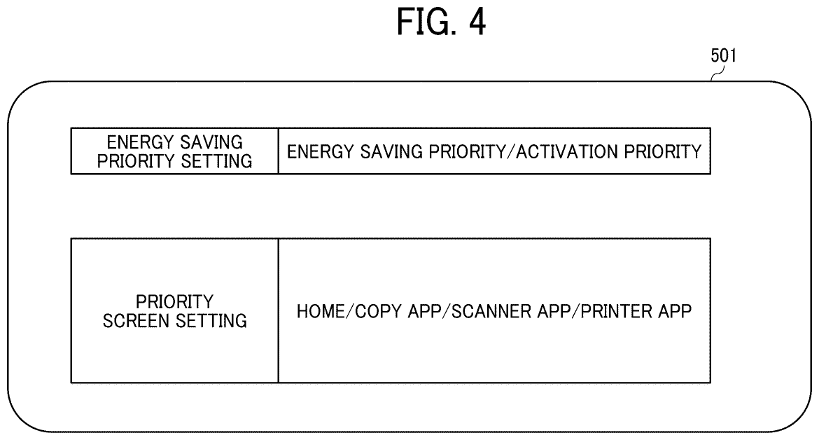

FIG. 4 is a diagram describing an example of a screen for performing initial setting.

The screen of FIG. 4 illustrates an example in which energy-saving priority setting for selecting either energy-saving priority or activation priority and priority screen setting for setting a screen to be preferentially displayed are provided as initial settings.

When the operation to perform the energy-saving priority setting (for example, click of energy-saving priority setting) is started, the selection unit 30 favorably displays a screen prompting the user to select the energy-saving priority or the activation priority, and receives the priority information selected by the user.

As the item of energy-saving priority and activation priority, for example, two options are displayed before one of energy-saving priority and activation priority is selected, and after one is selected, the selected one is displayed, or the colors of the selected one and the unselected other are changed, so that the selected one is clear.

For example, when an operation of performing the priority screen setting (for example, click of the priority screen setting) is started, the setting unit 40 favorably displays a screen prompting the user to set the priority screen, and receives screen setting information set by the user. The image forming apparatus 1 uses the operation screen set in the priority screen setting when a trigger for associating the operation screen is generated. The trigger for associating the operation screen is favorably, for example, when a trigger that does not specify activation of a specific application is generated, such as when the panel 501 of the operation unit 5 is operated or when opening and closing of the scanner cover, installation of a document, opening and closing of the printer cover, installation of a recording medium, or the like occurs.

For example, the items of HOME/copy app/scanner app/printer app are favorably configured such that the selectable HOME or application is displayed before the operation screen to be preferentially displayed is set, and the set HOME or application is displayed after the priority screen is set, or the set HOME or application and the HOME or application that is not set are displayed to be distinguished from each other.

Next, an operation example from generation of a predetermined trigger to display of an operation screen when the image forming apparatus 1 is in the energy-saving mode will be described.

FIG. 5 is a flowchart describing a processing example from generation of a predetermined trigger to screen display.

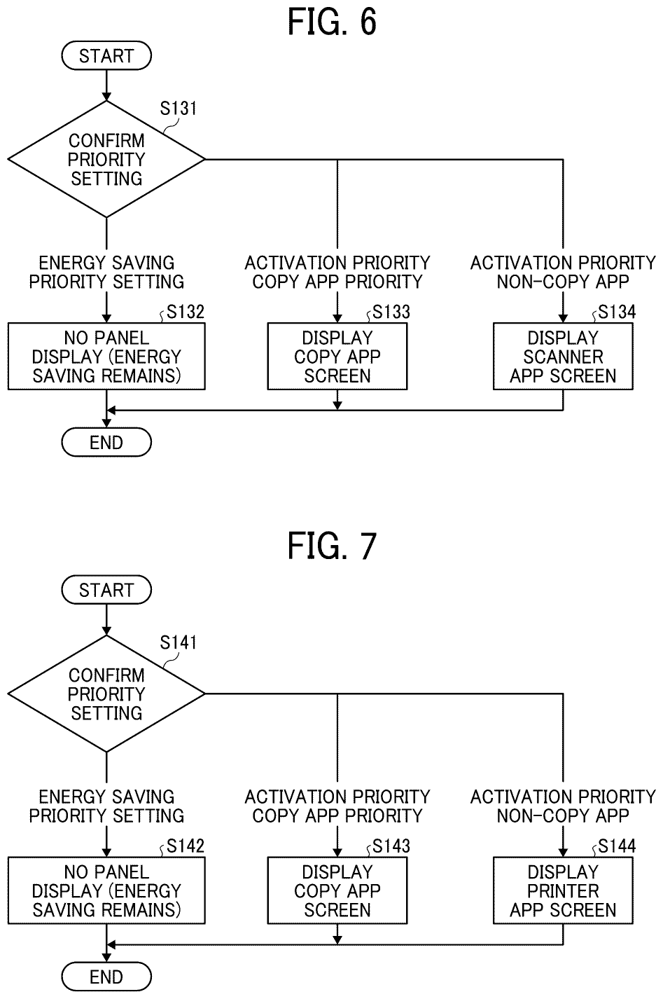

FIG. 6 is a flowchart describing a processing example from detection of a trigger of scanner cover open and scanner document set to a restoration operation.

FIG. 7 is a flowchart describing a processing example from detection of a trigger of printer cover open and printing document set to a restoration operation.

When the image forming apparatus 1 is operating in the energy-saving mode, the image forming apparatus 1 receives a predetermined trigger (operation trigger) by a user's operation to start the activation and energy saving restoration operation (S11). The image forming apparatus 1 determines an application to be restored and an operation screen at the time of restoration (a screen on which the application can be operated) on the basis of a predetermined trigger (S12), and performs a restoration operation (S15 to S18). The above is an outline, and the restoration operation will be described in detail.

When detecting that a predetermined trigger is generated (S11), the detection unit 10 notifies the determination unit 50 of a detection result.

When receiving the trigger detected by the detection unit 10, the determination unit 50 starts the energy saving restoration processing. The determination unit 50 identifies which of the following triggers the predetermined trigger is (S12).
Scanner cover open (opening and closing of the scanner cover)
Scanner document set (installation of document)
Printer cover open (opening and closing of the printer cover)
Printing document set (installation of recording medium)
Pressing of the operation panel (panel touch, opening and closing of the panel cover, or the like)
Copy job execution, scanner job execution, and printer job execution

The determination unit 50 refers to the priority information and confirms whether energy-saving priority or activation priority is selected. The determination unit 50 confirms the screen setting information, and confirms the screen setting of the copy app priority or the non-copy app screen setting.

The determination unit 50 determines the application to be restored from the energy-saving mode and the operation screen (a screen on which an application to be activated can be operated, a screen on which an application associated with a predetermined trigger can be operated, and the like) at the time of restoration to be displayed on the panel, which are associated with the identified trigger, by using the priority information and the screen setting information.

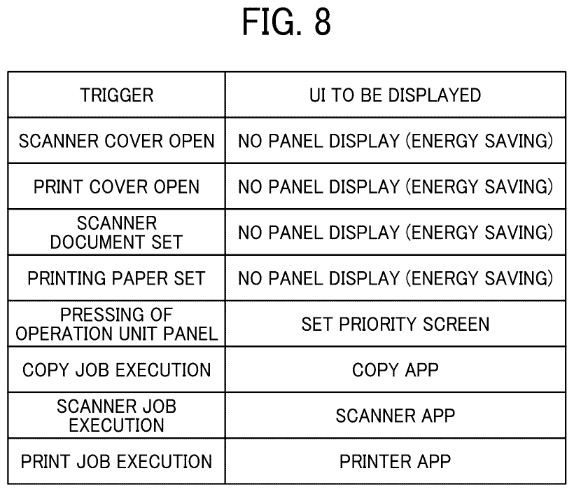

At this time, the determination unit 50 uses, for example, the correspondence examples illustrated in the tables of FIGS. 8 to 14.

FIG. 8 is a table illustrating a correspondence example between a trigger serving as a restoration factor and an application displayed on a panel in the case of energy-saving priority setting.

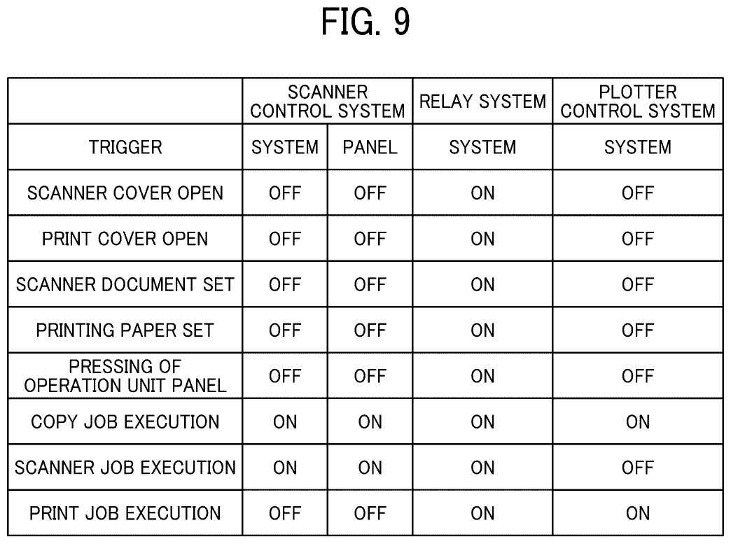

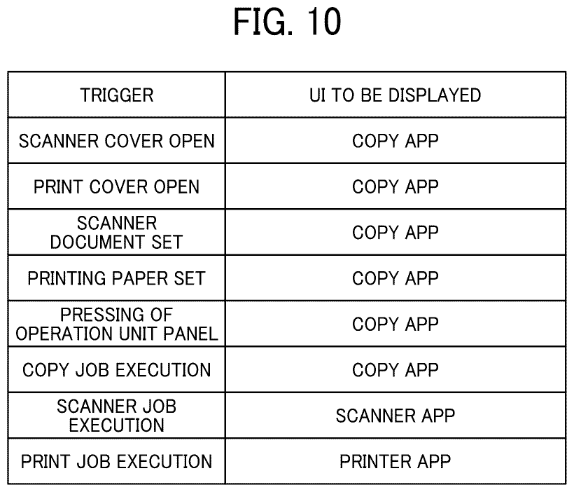

FIG. 9 is a table illustrating correspondence between a trigger serving as a restoration factor and system transition in the case of energy-saving priority setting.

FIG. 10 is a table illustrating a correspondence example between a trigger serving as a restoration factor and an application displayed on a panel in the case of activation priority and copy application priority setting.

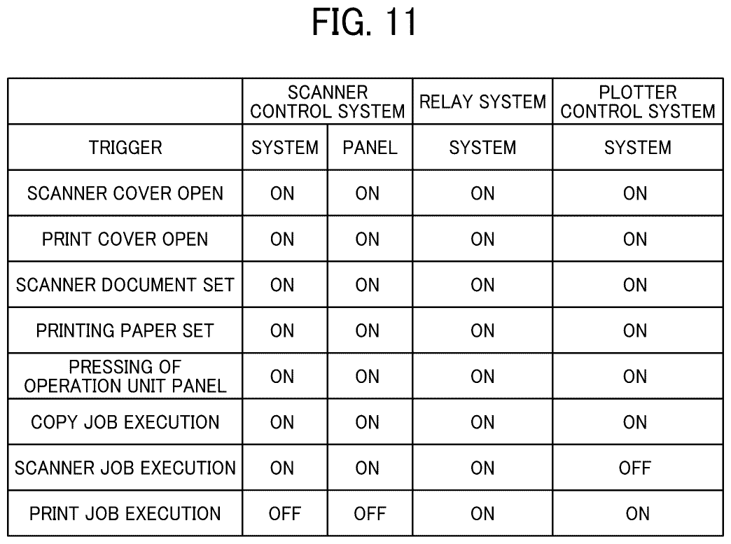

FIG. 11 is a table illustrating a correspondence example between a trigger serving as a restoration factor and system transition in the case of activation priority and copy application priority setting.

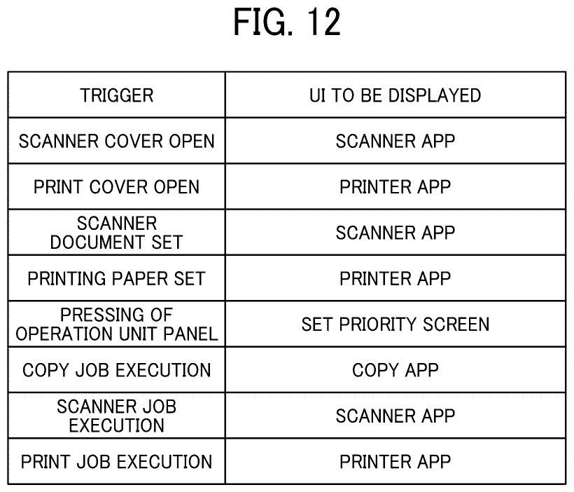

FIG. 12 is a table illustrating a correspondence example between a trigger serving as a restoration factor and an application displayed on a panel in the case of activation priority and non-copy application priority setting.

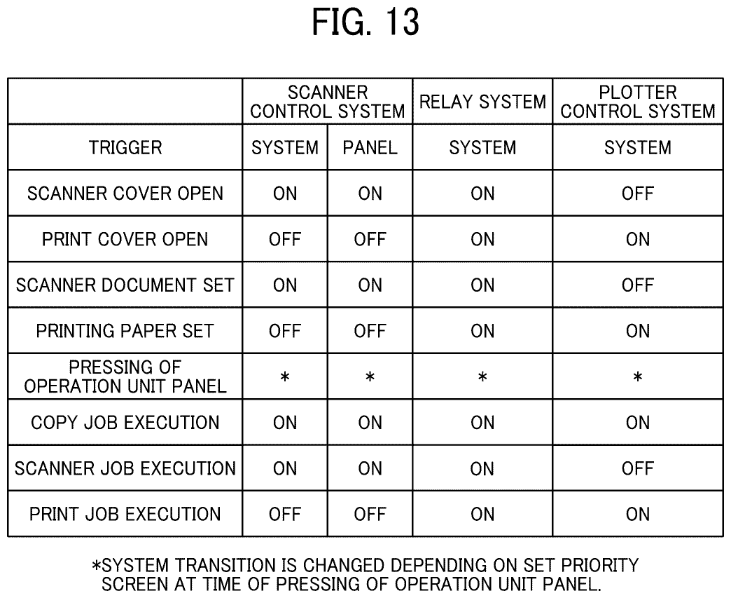

FIG. 13 is a table illustrating a correspondence example between a trigger serving as a restoration factor and system transition in the case of activation priority and non-copy application priority setting.

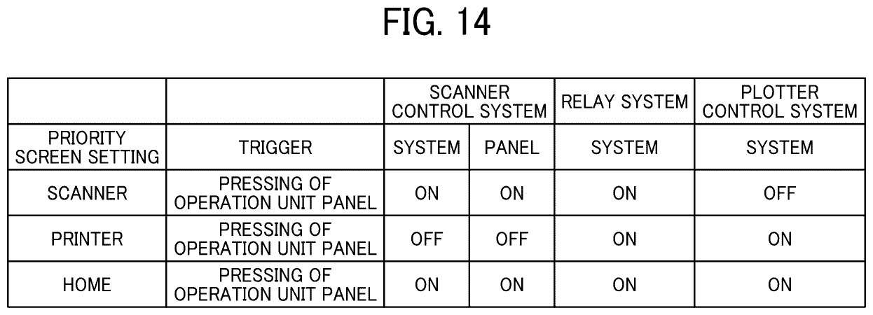

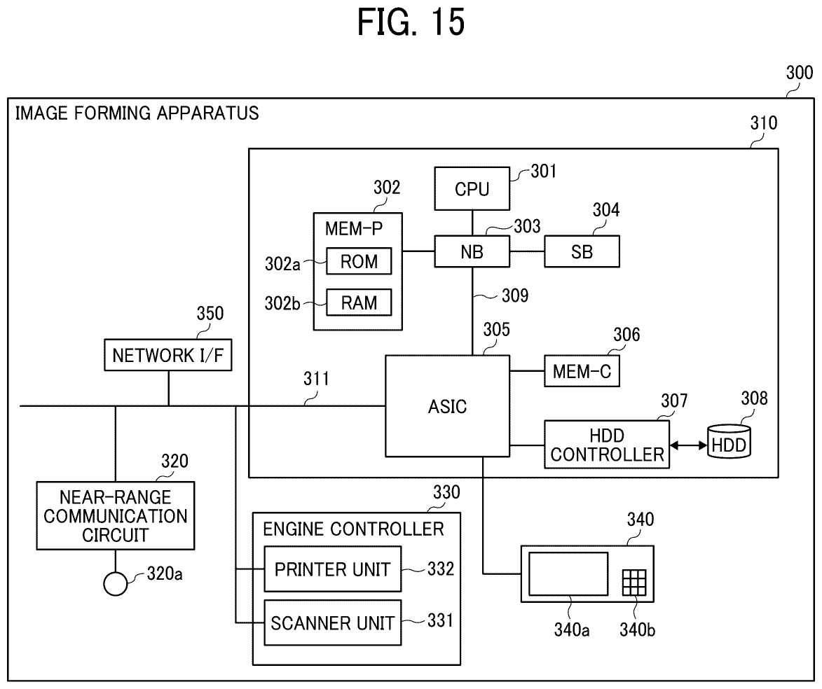

FIG. 14 is a table illustrating a correspondence example with system transition when pressing of an operation panel is used as a trigger of a restoration factor.

When the determination unit 50 determines that the operation trigger is “scanner cover open or scanner document set”, the processing in FIG. 6 is performed as the restoration operation (S13).

When the energy-saving priority is set to the confirmed priority information (S131), the determination unit 50 determines that the operation screen at the time of restoration is not displayed on the panel and the application to be restored is the relay system 4 according to the tables of FIGS. 8 and 9.

When the activation priority is set to the confirmed priority information (S131), the determination unit 50 makes the following determination using the screen setting information.

In the case of the activation priority and the copy app priority, the determination unit 50 determines that the operation screen at the time of restoration is the copy app and the application to be restored is the application that activates the scanner control system 2, the plotter control system 3, the relay system 4, and the operation unit 5 according to the tables of FIGS. 10 and 11.

In the case of the activation priority and the non-copy app, the determination unit 50 determines that the operation screen at the time of restoration is the scanner app and the application to be restored is the scanner control system 2, the relay system 4, and the operation unit 5 according to the tables of FIGS. 12 and 13.

When the determination unit 50 determines that the operation trigger is “printer cover open or printing document set”, the processing in FIG. 7 is performed as the restoration operation (S14).

When the energy-saving priority is set to the confirmed priority information (S141), the determination unit 50 determines that the operation screen at the time of restoration is not displayed on the panel and the application to be restored is the relay system 4 according to the tables of FIGS. 8 and 9.

When the activation priority is set to the confirmed priority information (S141), the determination unit 50 makes the following determination using the screen setting information.

In the case of the activation priority and the copy app priority, the determination unit 50 determines that the operation screen at the time of restoration is the copy app and the application to be restored is the scanner control system 2, the plotter control system 3, the relay system 4, and the operation unit 5 according to the tables of FIGS. 10 and 11.

In the case of the activation priority and the non-copy app, the determination unit 50 determines that the operation screen at the time of restoration is the scanner app and the application to be restored is the plotter control system 3 and the relay system 4 according to the tables of FIGS. 12 and 13.

When the determination unit 50 determines that the operation trigger is “pressing of the operation panel”, when the energy-saving priority is selected, the determination unit determines that the operation screen at the time of restoration is the set priority screen and the application to be restored is the relay system 4 according to the tables of FIGS. 8 and 9.

When the activation priority is selected, the determination unit 50 makes the following determination using the screen setting information.

In the case of the activation priority and the copy app priority, the determination unit 50 determines that the operation screen at the time of restoration is the copy app and the application to be restored is the scanner control system 2, the plotter control system 3, the relay system 4, and the operation unit 5 according to the tables of FIGS. 10 and 11.

In the case of the activation priority and the non-copy app, the determination unit 50 determines that the operation screen at the time of restoration is the set priority screen (scanner, printer, and HOME) and the application to be restored according to the tables of FIGS. 12 and 14. The determination unit 50 makes a determination according to the correspondence illustrated in FIG. 14 according to the priority screen, and for example, in the case of the activation priority and the priority screen setting being HOME, the entire system is turned on so that all applications can be handled.

When determining that the operation trigger is “copy job execution”, the determination unit 50 determines that the operation screen at the time of restoration is the copy app, and the application to be restored is the scanner control system 2, the plotter control system 3, the relay system 4, and the operation unit 5, regardless of the priority information and the screen setting information.

When determining that the operation trigger is “scanner job execution”, the determination unit 50 determines that the operation screen at the time of restoration is the scanner app, and the application to be restored is the scanner control system 2, the relay system 4, and the operation unit 5, regardless of the priority information and the screen setting information.

When determining that the operation trigger is “printer job execution”, the determination unit 50 determines that the operation screen at the time of restoration is the printer app, and the application to be restored is the plotter control system 3 and the relay system 4, regardless of the priority information and the screen setting information.

The activation control unit 60 receives the determination result of the determination unit 50, controls the restoration of the application to be restored, and activates the application to activate (restore) the corresponding system or the like (scanner control system 2, plotter control system 3, relay system 4, or operation unit 5).

The display control unit 70 receives the determination result of the determination unit 50 and displays an application to be displayed at the time of restoration on the panel (S15 to S18, S132 to S134, and S142 to S144).

The tables illustrated in FIGS. 8 to 14 are favorably stored in advance in the storage area that can be referred to by the determination unit 50, for example. The image forming apparatus 1 may include, for example, a storage unit that stores information of the above-described tables, and the determination unit 50 may proceed with processing with reference to the storage unit. Alternatively, when the determination unit 50 is implemented by a program, the information of the above-described tables may be held (set) in a program for implementing the determination unit 50.

As described above, when restoring from the energy-saving mode, the image forming apparatus 1 changes the energy-saving priority or the activation priority and the application to be displayed on the panel of the operation unit on the basis of not only the restoration factor (cover opening and closing, document and paper set, or the like) but also information set in advance by the user. In this way, it is possible to implement restoration from the energy-saving mode intended by the user, for example, system transition and operation screen display of a desired application. It is possible to prevent an application screen not intended by the user from being displayed, and it is possible to switch the display of the operation panel to the screen of the application on the basis of the restoration factor and the designation by the user.

### Modification

In the above-described embodiment, the selection unit 30 receives the priority information selected by the user via the panel 501, but the priority information selected in advance by the user or the like may be received from an external information processing terminal or the like via communication.

Similarly, the setting unit 40 receives the screen setting information set by the user via the panel 501, but the screen setting information set in advance by the user or the like may be received from an external information processing terminal or the like via communication.

When notifying the determination unit 50 of the priority information, the selection unit 30 may notify the determination unit 50 of the priority information by writing the priority information in a storage area that can be referred to by the determination unit 50, and it is sufficient when it is a way as long as the determination unit 50 can acquire the priority information.

When notifying the determination unit 50 of the screen setting information, the setting unit 40 may notify the determination unit 50 of the screen setting information by writing the screen setting information in a storage area that can be referred to by the determination unit 50, and it is sufficient when it is a way as long as the determination unit 50 can acquire the screen setting information.

In the image forming apparatus, in a configuration in which the information of the tables in FIGS. 8 to 14 is stored in a recording unit or the like, the information of each table may be changeable via the panel 501 of the operation unit 5 or an external information processing apparatus or the like. In this way, the user can flexibly change the activation of the system and the energy saving restoration according to the use situation.

In the above-described embodiment, the control device may be implemented by, for example, a program, or may be implemented by combining a program and hardware.

### Hardware Configuration of Image Forming Apparatus

Next, a hardware configuration example of the image forming apparatus 1 described in the above embodiment will be described using an image forming apparatus 300 with reference to FIG. 15. FIG. 15 is a block diagram describing an example of a hardware configuration of the image forming apparatus.

The image forming apparatus 300 is constructed by a multifunction peripheral/product/printer (MFP) or the like. The image forming apparatus 300 includes a controller 310, a near-range communication circuit 320, an engine control unit 330, an operation panel 340, and a network I/F 350.

The controller 310 controls the entire image forming apparatus 300, and controls, for example, drawing, communication, input from the operation panel 340, and the like. Specifically, the controller 310 includes the CPU 301, which is a main part of a computer, the MEM-P 302, a north bridge (NB) 303, a south bridge (SB) 304, an application specific integrated circuit (ASIC) 305, the MEM-C 306, which is a storage unit, an HDD controller 307, and an HDD 308, which is a storage unit, and the NB 303 and the ASIC 305 are coupled by an accelerated graphics port (AGP) bus 309.

The CPU 301 is a control unit that controls the entire image forming apparatus 300.

The NB 303 is a bridge for coupling the CPU 301, the MEM-P 302, the SB 304, and the AGP bus 309, and includes a memory controller that controls reading and writing from and to the MEM-P 302, a peripheral component interconnect (PCI) master, and an AGP target.

The MEM-P 302 includes read only memory (ROM) 302a, which is a memory for storing a program and data for implementing each function of the controller 310, and random access memory (RAM) 302b, which is used as a drawing memory or the like at the time of loading the program and the data and memory printing.

The program stored in the ROM 302a may be provided by being recorded in a computer-readable recording medium such as a compact disk (CD)-ROM, a CD-recordable (CD-R), and a digital versatile disk (DVD) as a file in an installable format or an executable format.

The SB 304 is a bridge for coupling the NB 303 to a PCI device and a peripheral device.

The ASIC 305 is an integrated circuit (IC) for image processing having a hardware element for image processing, and serves as a bridge that couples the AGP bus 309, a PCI bus 311, the HDD 308, and the MEM-C 306.

The ASIC 305 includes a PCI target, an AGP master, an arbiter (ARB) that forms the core of the ASIC 305, a memory controller that controls the MEM-C 306, multiple direct memory access controllers (DMAC) that rotates image data by hardware logic or the like, and a PCI unit that performs data transfer between a scanner unit 331 and a printer unit 332 via the PCI bus 311.

An interface of a universal serial bus (USB) or an interface of Institute of Electrical and Electronics Engineers 1394 (IEEE 1394) may be coupled to the ASIC 305.

The MEM-C 306 is a local memory used as a copy image buffer and a code buffer.

The HDD 308 is a storage for accumulating image data, accumulating font data used at the time of printing, and accumulating forms. The HDD controller 307 controls reading or writing of data with respect to the HDD 308 according to the control of the CPU 301.

The AGP bus 309 is a bus interface for a graphics accelerator card proposed for speeding up graphics processing, and can speed up the graphics accelerator card by directly accessing the MEM-P 302 with high throughput.

The near-range communication circuit 320 includes a near-range communication circuit 920a. The near-range communication circuit 320 is a communication circuit such as near field communication (NFC) or Bluetooth (registered trademark).

The engine control unit 330 includes the scanner unit 331 and the printer unit 332. The scanner unit 331 or the printer unit 332 includes an image processing portion such as error diffusion or gamma conversion.

The operation panel 340 includes a panel display unit 340a such as a touch panel that displays a current setting value, a selection screen, and the like and receives an input from an operator, and an operation panel 340b including a numeric keypad that receives a setting value of a condition related to image formation such as a density setting condition, a start key that receives a copy start instruction, and the like.

The operation panel 340 can be used as a panel included in the operation unit 5 illustrated in FIG. 1, and for example, the operation panel 340 may be managed by the scanner control system 2 as illustrated in FIG. 1 and the like.

The image forming apparatus 300 can sequentially switch and select a document box function, a copy function, a printer function, and a facsimile function by an application switching key of the operation panel 340. A document box mode is set when the document box function is selected, a copy mode is set when the copy function is selected, a printer mode is set when the printer function is selected, and a facsimile mode is set when the facsimile mode is selected.

The network I/F 350 is an interface for data communication through a communication network NT. The near-range communication circuit 320 and the network I/F 350 are electrically coupled to the ASIC 305 via the PCI bus 311.

An image forming apparatus includes: a scanner to read an image on a document, the scanner including an operation unit including a panel; a plotter to print the image read by the scanner on a medium; a relay to relay the scanner and the plotter; a detector to detect a trigger generated by at least one of the scanner, the plotter, or the operation unit; and circuitry configured to control the scanner, the plotter, the relay, and the operation unit to: shift an operation state of at least one of multiple applications to operate the scanner, the plotter, the relay, and the operation unit to an energy-saving mode when the operation unit receives an instruction to shift the operation state to the energy-saving mode; receive, in advance from the operation unit, priority information to select one of: energy-saving priority to select the energy-saving mode over an activation mode; and activation priority to select the activation mode to activate the multiple applications over the energy-saving mode, from the operation unit; receive, in advance from the operation unit, screen setting information to set an operation screen displayed with priority on the panel among multiple operation screens; determine: an application to be restored from the energy-saving mode among the multiple applications; and an operation screen to be displayed on the panel at a time of restoration from the energy-saving mode among the multiple operation screens, based on the trigger detected by the detector, the priority information, and the screen setting information; display, on the panel, the operation screen at the time of restoration; and activate the application to be restored.

The scanner includes a scanner cover, the plotter includes a printer cover, the circuitry is further configured to: receive the trigger including at least one of: an opening and closing of the scanner cover; an opening and closing of the printer cover; an installation of the document in the scanner; an installation of the medium in the plotter; an operation to the panel of the operation unit; a copy job execution; a scanner job execution; or a printer job execution; receive the screen setting information that sets the operation screen to display with priority any one of: a screen of a copy application; a screen of a scanner application; a screen of a printer application; or a home screen; and switch the application to be restored and the operation screen at the time of restoration according to each case of: energy-saving priority; the activation priority and the screen of the copy application set in the screen setting information; and the activation priority and a screen other than the copy application set in the screen setting information.

The circuitry is further configured to: determine the operation screen at the time of restoration to be displayed on the panel when the trigger detected by the detector is a first trigger including: the operation on the panel; the copy job execution; the scanner job execution; and the printer job execution, when the energy-saving priority is selected; and determine not to display the operation screen at the time of restoration on the panel when the trigger detected by the detector is a second trigger other than the first trigger.

The circuitry is further configured to: determine the screen of the scanner application as the operation screen at the time of restoration, when the trigger detected by the detector is the scanner job execution, and when the activation priority is selected and the screen of the copy application is set in the screen setting information; determine the screen of the printer application as the operation screen at the time of restoration when the trigger detected by the detector is the printer job execution; and determine the screen of the copy application as the operation screen at the time of restoration when the trigger detected by the detector is a trigger other than the scanner job execution and the printer job execution.

The circuitry is further configured to: set the screen of the scanner application as the operation screen at the time of restoration, when the trigger detected by the detector is one of: the opening and closing of the scanner cover; the installation of the document; and the scanner job execution, and the activation priority is selected and a screen other than the screen of the copy application is set in the screen setting information; set the screen of the printer application as the operation screen at the time of restoration when the trigger detected by the detector is one of: the opening and closing of the printer cover; the installation of the medium; and the printer job execution; and set a screen of the priority information as the operation screen at the time of restoration when the trigger detected by the detector is the operation on the panel.

According to the present embodiment, it is possible to improve the usability of activation and energy-saving restoration of an image forming apparatus including multiple systems.

Aspects of the present embodiment are, for example, as follows.

### Aspect 1

According to Aspect 1, an image forming apparatus includes: a scanner control system that controls a scanner; a plotter control system that controls a plotter; a relay system that controls the scanner control system and the plotter control system and relays a request from an external device; an operation unit that includes a panel; an energy saving control device that shifts an operation state of at least one of multiple applications for operating the scanner control system, the plotter control system, the relay system, and the operation unit to an energy-saving mode when an instruction to shift to the energy-saving mode is received; a selection device that receives in advance priority information in which one of energy-saving priority prioritizing the energy saving and activation priority prioritizing activation of the application is selected; a setting device that receives in advance screen setting information in which an operation screen to be preferentially displayed is set among multiple operation screens; a detection device that detects a predetermined trigger generated by at least one of the scanner control system, the plotter control system, or the operation unit; a determination device that determines an application to be restored from the energy-saving mode among the multiple applications and an operation screen to be displayed at a time of restoration on the panel among the multiple operation screens based on the detected trigger, the priority information, and the screen setting information; a display control device that displays an operation screen at the time of restoration on the panel based on the determination by the determination device; and an activation control device that controls activation of the application to be restored based on determination by the determination device.

### Aspect 2

According to Aspect 2, in the image forming apparatus of Aspect 1, the detected trigger is at least one of opening and closing of a scanner cover included in the scanner control system, opening and closing of a printer cover included in the plotter control system, installation of a document in the scanner control system, installation of a recording medium in the plotter control system, an operation on a panel included in the operation unit, copy job execution, scanner job execution, or printer job execution, the screen setting information is an operation screen in which any one of a screen of a copy application, a screen of a scanner application, a screen of a printer application, and a home screen is set as the operation screen to be preferentially displayed, and the determination device determines the application to be restored and the operation screen at the time of restoration separately for a case of energy-saving priority, a case of the activation priority and setting the screen of the copy application in the screen setting information, and a case of the activation priority and setting other than the screen of the copy application in the screen setting information.

### Aspect 3

According to Aspect 3, in the image forming apparatus of Aspect 2, the determination device determines the operation screen at the time of restoration when the detected trigger is the operation on the panel, the copy job execution, the scanner job execution, and the printer job execution in a case of the energy-saving priority, and determines not to display the operation screen at the time of restoration on the panel when the detected trigger is another trigger.

### Aspect 4

According to Aspect 4, in the image forming apparatus of Aspect 2 or 3, in a case of the activation priority and setting the screen of the copy application in the screen setting information, the determination device determines that the operation screen at the time of restoration is the screen of the scanner application when the detected trigger is the scanner job execution, the operation screen at the time of restoration is the screen of the printer application when the detected trigger is the printer job execution, and the operation screen at the time of restoration is the screen of the copy application when the detected trigger is another trigger.

### Aspect 5

According to Aspect 5, in the image forming apparatus of any one of Aspects 2 to 4, in a case of the activation priority and setting other than the screen of the copy application in the screen setting information, the determination device sets the operation screen at the time of restoration as the screen of the scanner application when the detected trigger is the opening and closing of the scanner cover, the installation of the document, and the scanner job execution, sets the operation screen at the time of restoration as the screen of the printer application when the detected trigger is the opening and closing of the printer cover, the installation of the recording medium, and the printer job execution, and makes a determination based on the screen setting information when the detected trigger is the operation on the panel.

The present embodiment is not limited to the embodiment described above. Within the scope of the present embodiment, it is possible to change, add, and convert each element of the above-described embodiment into contents that person skilled in the art can easily conceive.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. An image forming apparatus comprising:
a scanner to read an image on a document, the scanner including an operation unit including a panel;
a plotter to print the image read by the scanner on a medium;
a relay to relay the scanner and the plotter;
a detector to detect a trigger generated by at least one of the scanner, the plotter, or the operation unit; and
circuitry configured to control the scanner, the plotter, the relay, and the operation unit to:
shift an operation state of at least one of multiple applications to operate the scanner, the plotter, the relay, and the operation unit to an energy-saving mode when the operation unit receives an instruction to shift the operation state to the energy-saving mode;
receive, in advance from the operation unit, priority information to select one of:
energy-saving priority to select the energy-saving mode over an activation mode; and
activation priority to select the activation mode to activate the multiple applications over the energy-saving mode,
from the operation unit;
receive, in advance from the operation unit, screen setting information to set an operation screen displayed with priority on the panel among multiple operation screens;
determine:
an application to be restored from the energy-saving mode among the multiple applications; and
an operation screen to be displayed on the panel at a time of restoration from the energy-saving mode among the multiple operation screens,
based on the trigger detected by the detector, the priority information, and the screen setting information;
display, on the panel, the operation screen at the time of restoration; and
activate the application to be restored.

2. The image forming apparatus according to claim 1,
wherein the scanner includes a scanner cover,
the plotter includes a printer cover,
the circuitry is further configured to:
receive the trigger including at least one of:
an opening and closing of the scanner cover;
an opening and closing of the printer cover;
an installation of the document in the scanner;
an installation of the medium in the plotter;
an operation to the panel of the operation unit;
a copy job execution;
a scanner job execution; or
a printer job execution;
receive the screen setting information that sets the operation screen to display with priority any one of:
a screen of a copy application;
a screen of a scanner application;
a screen of a printer application; or
a home screen; and
switch the application to be restored and the operation screen at the time of restoration according to each case of:
energy-saving priority;
the activation priority and the screen of the copy application set in the screen setting information; and
the activation priority and a screen other than the copy application set in the screen setting information.

3. The image forming apparatus according to claim 2,
wherein the circuitry is further configured to:
determine the operation screen at the time of restoration to be displayed on the panel when the trigger detected by the detector is a first trigger including:
the operation on the panel;
the copy job execution;
the scanner job execution; and
the printer job execution,
when the energy-saving priority is selected; and
determine not to display the operation screen at the time of restoration on the panel when the trigger detected by the detector is a second trigger other than the first trigger.

4. The image forming apparatus according to claim 2,
wherein the circuitry is further configured to:
determine the screen of the scanner application as the operation screen at the time of restoration,
when the trigger detected by the detector is the scanner job execution, and
when the activation priority is selected and the screen of the copy application is set in the screen setting information;
determine the screen of the printer application as the operation screen at the time of restoration when the trigger detected by the detector is the printer job execution; and
determine the screen of the copy application as the operation screen at the time of restoration when the trigger detected by the detector is a trigger other than the scanner job execution and the printer job execution.

5. The image forming apparatus according to claim 2,
wherein the circuitry is further configured to:
set the screen of the scanner application as the operation screen at the time of restoration,
when the trigger detected by the detector is one of:
the opening and closing of the scanner cover;
the installation of the document; and
the scanner job execution, and
the activation priority is selected and a screen other than the screen of the copy application is set in the screen setting information;
set the screen of the printer application as the operation screen at the time of restoration when the trigger detected by the detector is one of:
the opening and closing of the printer cover;
the installation of the medium; and
the printer job execution; and
set a screen of the priority information as the operation screen at the time of restoration when the trigger detected by the detector is the operation on the panel.
